(19) United States
(12) Patent Application Publication
(10) Pub. No.: US 2009/0244763 A1
(43) Pub. Date: Oct. 1, 2009

(54) ELECTRONIC INFORMATION STORAGE APPARATUS, INFORMATION PROCESSING APPARATUS, IMAGE FORMING APPARATUS, AND COMPUTER READABLE MEDIUM

(75) Inventors: Shohei IKENOUE, Saitama-shi (JP); Jun SATO, Saitama-shi (JP); Kentaro FUKAMI, Saitama-shi (JP); Akiyoshi OSUGI, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/248,133

(22) Filed: Oct. 9, 2008

(30) Foreign Application Priority Data
Mar. 25, 2008 (JP) 2008-078219

(51) Int. Cl. G11B 15/18

(52) U.S. Cl. 360/71

(57) ABSTRACT

An electronic information storage apparatus includes: a storage that stores electronic information; a check unit that reads out the electronic information stored in the storage to check whether the electronic information is written normally or not; and a controller that, in a case where the electronic information is stored in the storage under a predetermined condition, controls the check unit to carry out an operation to check a state of writing of the electronic information.

### CROSS-REFERENCE TO RELATED APPLICATIONS

This application is based on and claims priority under 35 U.S.C. 119 from Japanese Patent Application No. 2008-078219 filed Mar. 25, 2008.

### BACKGROUND

1. Technical Field

The present invention relates to an electronic information storage apparatus, an information processing apparatus, an image forming apparatus, and a computer readable medium.

2. Related Art

Storage means such as a hard disk drive (which is hereinafter referred to as an HDD) is used mainly in a computer and, recently, the storage means has been increasingly used in a car navigation system, a game, office equipment and the like, while the number of use of the storage means in them has also been increasing.

In an HDD, a disk coated with a magnetic substance is rotated at a high speed and, using a head which is floated due to the rotation of the disk, data are read and written. With an advance in recording and reproduction technology, the capacity of the HDD has been increasing at an annual rate of ten and several %.

The number of disks and the number of heads in the inside of the HDD are fixed and an increase in the HDD capacity is realized by increasing the recording density of the HDD. For this purpose, the positioning precision and float height of the head as well as a write current to be applied to the head are controlled at a high speed and with high accuracy.

### SUMMARY

According to an aspect of the present invention, an electronic information storage apparatus includes: a storage that stores electronic information; a check unit that reads out the electronic information stored in the storage to check whether the electronic information is written normally or not; and a controller that, in a case where the electronic information is stored in the storage under a predetermined condition, controls the check unit to carry out an operation to check a state of writing of the electronic information.

### BRIEF DESCRIPTION OF THE DRAWINGS

Exemplary embodiment of the present invention will be described in detail based on the following figures, wherein:

FIG. 1 is a block diagram of an example of the whole structure of an information machine according to an embodiment of the invention;

FIG. 2 is a block diagram of an example of the structure of a storage part according to the embodiment of the invention;

FIG. 3 is a flow chart of a procedure for a writing processing to be executed by the information machine according to the embodiment of the invention;

FIG. 4 is a view of an example of writing confirmation conditions according to the embodiment of the invention;

FIG. 5 is a view of a setting example of writing confirmation conditions according to the embodiment of the invention; and

FIG. 6 is a view of another setting example of writing confirmation conditions according to the embodiment of the invention.

### DETAILED DESCRIPTION

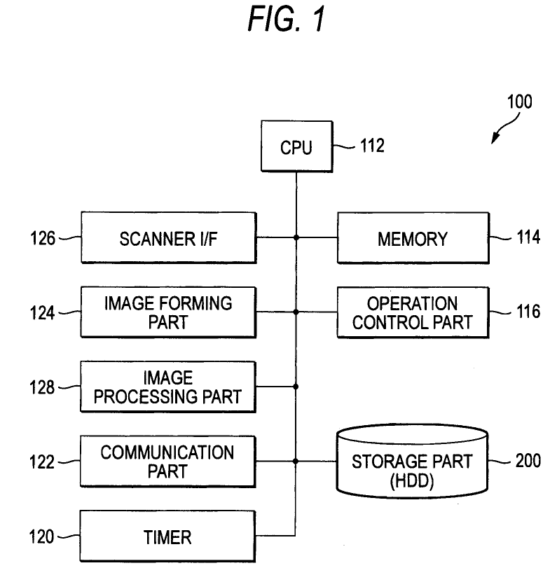

Now, description will be given below of the best mode for carrying out the invention (which is hereinafter referred to as an embodiment) with reference to the accompanying drawings. FIG. 1 shows a general structure of an image forming apparatus (a so called a composite machine) 100 having a plurality of functions such as a communication function and an image forming (copying and printing) function, as an example of an information processing apparatus having an information storage function according to the present embodiment. As an example of an information processing apparatus, besides a composite machine, there are available an image processing apparatus, a facsimile apparatus and the like. Also, as an image forming apparatus, according to the present embodiment, there is shown an image forming apparatus which is incorporated in a composite machine; however, the invention is not limited to this, but the invention can also apply to, for example, a printing apparatus which has an image forming function as its primary function.

The composite machine 100 includes a control part (for example, a CPU) 112 for controlling the whole of the composite machine 100, a memory (for example, a memory such as an SRAM having a relatively high access speed) 114, and a plurality of function parts. In the example shown in FIG. 1, the composite machine 100 includes an image read part and its scanner (scanner I/F) 126, an image forming part (an image forming part of, for example, an electrophotographic type, an ink jet type, and a thermal type) 124, a communication part (for example, a facsimile communication part connected to a communication network such as a telephone line or an internet) 122, and an image processing part 128 for enforcing an image processing (an image processing such as a color conversion processing and a gradation conversion processing) on image information input from the communication part 122, scanner I/F 126 and the like. Also, the composite machine 100 includes an operation control part 116 for controlling the operations of the respective function parts, and a timer 120 for managing the time of the respective function parts; and further, it includes a storage part 200 for storing therein electronic information obtained by the respective function parts or electronic information to be used in the respective function parts. According to the present embodiment, there is employed a structure in which the control part 112 for controlling the whole of the composite machine 100 and the operation control part 116 are provided separately. However, there may also be employed a structure in which the above two control parts are unified together.

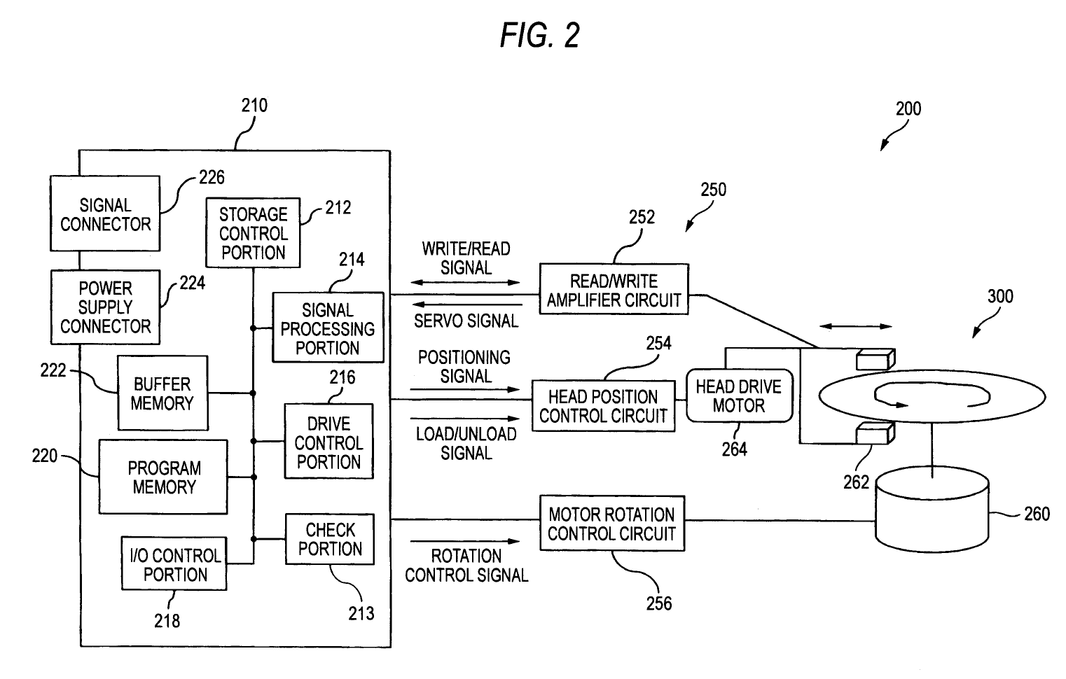

The storage part 200, as an example, includes a structure shown in FIG. 2. Here, there is employed a hard disk drive (HDD: a fixed disk drive). Besides the HDD, there can also be employed a storage part which uses a nonvolatile semiconductor storage device such as a flash memory. When the present embodiment is applied to a semiconductor storage apparatus, a disk 300 to be discussed below can be replaced with a storage part which is composed of a semiconductor. And, the storage part 200 includes a control part 210 serving also as an interface on the HDD side, a drive part 250, a disk 300, a disk drive motor 260 for driving the disk 300, a head 262 for writing information into the disk 300, and a drive motor 264 for driving the head 262.

The control part 210, which is provided within the storage part 200, includes a storage control portion 212 for controlling the whole of the storage part 200, a check portion 213 for checking whether electronic information stored into the disk 300 (storage part 210) has been written normally or not, a signal processing portion 214 for processing signals such as a write-read signal and an address signal, a drive part control portion 216 for outputting a signal for controlling the operation of the drive part 250, an I/O control portion 218 for controlling an input/output operation between the control part 210 and the main body of the composite machine 100 on which the storage part 200 is to be mounted, a program memory 220 for storing a program to be executed by the hard disk drive, a buffer memory 222 for temporarily storing write information and read information, a power supply connector 224 for supplying power supplied from the main body of the composite machine 100 into the storage part 200, a signal connector portion 226 for transmitting and receiving the write and read electronic information between the main body of the composite machine 100 and disk 300, and the like.

The drive part 250 includes an amplifier circuit 252, a head position control circuit 254, a motor rotation control circuit 256 and the like. The amplifier circuit 252 not only amplifies a signal supplied from the control part 210 and written into the disk 300 by the head 262 and supplies the amplified signal to the head 262 but also amplifies a signal read from the disk 300 by the head 262 and a servo signal and supplies the amplified signals to the control part 210. The head position control circuit 254, based on a positioning signal, a load signal and an unload signal respectively supplied from the control part 210, supplies a drive signal, which is used by the head drive motor 264 to position the head 262, to the head drive motor 264. The motor rotation drive circuit 256, based on a rotation control signal supplied from the control part 210, supplies a drive signal, which is used by the motor 260 to rotate the disk 300, to the motor 260.

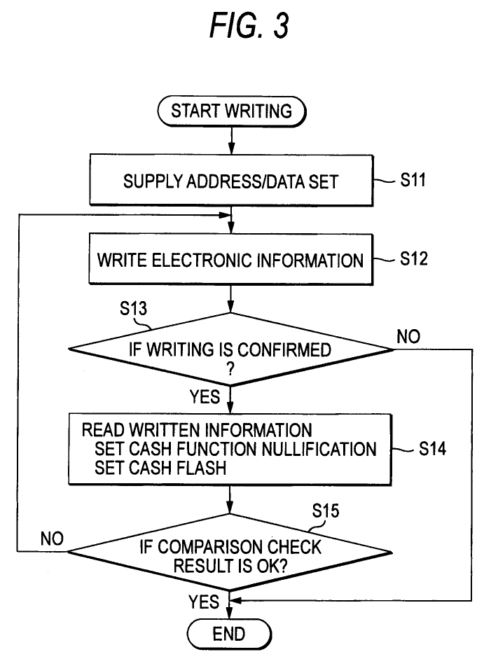

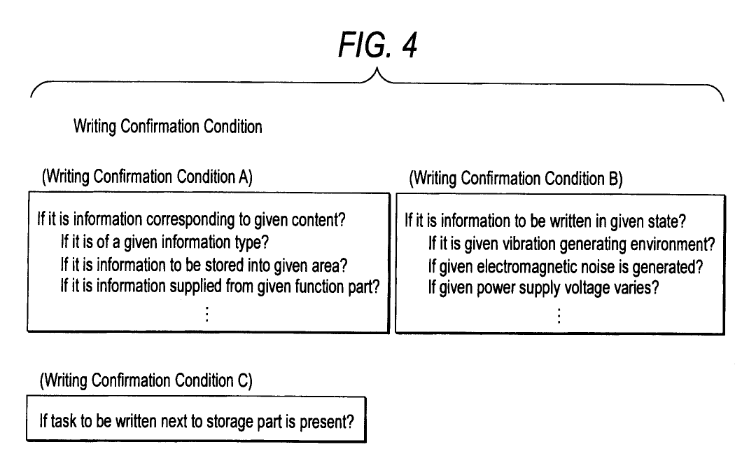

Information equipment such as a composite machine includes the above-structured storage part 200 and, according to the present embodiment, using the following procedure, when electronic information is written into the storage part 200, the writing of the electronic information is confirmed. Now, description will be given below of the writing confirmation with further reference to FIGS. 3 and 4. FIG. 3 shows the writing procedure according to the present embodiment, and FIG. 4 shows the conditions of the writing confirmation according to the present embodiment.

According to the present embodiment, when electronic information written into the storage part 200 is a given piece of information set such that it must be checked for the writing thereof, the written electronic information is read out again and is compared with the original electronic information to thereby confirm whether it has been written correctly. Here, when the writing confirmation operation is not executed, data may simply be transmitted from a storage control part provided on the main body of the composite machine 100 to the storage part 200, thereby ending the writing processing.

The storage control portion 212, based on an instruction issued from the CPU 112 or the like, carries out an operation to control the writing and reading of electronic information with respect to the storage part 200. The check portion 213 checks whether the electronic information has been written correctly or not.

When checking whether the electronic information has been written correctly into the storage part 200 or not, the check portion 213 carries out the checking operation in the following manner. That is, electronic information to be written into the storage part 200 is stored once into, for example, the memory butter 222, and, while maintaining the storage of the electronic information, the electronic information is written into the disk 300. After the electronic information is written into the disk 300, the electronic information written into the disk 300 is read out by the check portion 213; and, the check portion 213 compares the data contents of the thus read-out electronic information with the data contents of the electronic information stored in the memory butter 222. When, as the result of this comparison, it is found that they are coincident with each other, it is determined that the writing of the electronic information into the storage part 200 has been carried out correctly. This series of control operations are to be carried out by, for example, the storage control portion 212.

When the check portion 213 checks whether the writing of the electronic information has been executed correctly or not, the writing of the electronic information is confirmed under the control of the storage control portion 212 according to previously set conditions. From the check result provided by the check portion 213, when it is found that the information writing has not been executed properly, the electronic information is written again.

Here, the above-mentioned writing check and control of such check may also be carried out by the CPU 112 or by the above-mentioned storage control portion 212. Also, the check portion 213 and control portion (212 or 112) may also be composed of an integrated circuit in which a function portion is incorporated as a circuit element, or a portion of the function or the whole of the function may also be realized by a program. When the function is realized by a program, the program can be operated in such a manner that it is stored into a desired memory medium and is installed into a computer apparatus.

Now, description will be given below specifically of the writing check processing with further reference to FIG. 3. When a write instruction is given from the CPU 112 or the like, the storage control portion 212 supplies an address signal for the writing destination of the disk 300 and electronic information to be written into the storage part 200 (S11). In the storage part 200, the control part 210, drive part 250, motors 260, 264 and head 262 are respectively operated to thereby write the electronic information into the disk 300 (S12). Also, the storage control portion 212, which is provided on the main body of the composite machine 100, checks whether the state of writing of the written electronic information must be confirmed or not (S13). When the confirmation of the writing of the written electronic information is found not necessary (S13, No), the information writing processing is ended. On the other hand, when the information writing confirmation is found necessary (S13, Yes), the control part 210, drive part 250, motors 260, 264 and head 262 of the storage part 200 are respectively controlled to thereby read out the electronic information, which should have been written, from the disk 300 (S14).

Here, when the storage part 200 has a cash flash function or a cash function removing function, at least prior to execution of the information writing confirmation, a cash flash must be carried out or a cash function must be removed. That is, when the written electronic information is stored in the buffer memory 222 of the storage part 200 or the like, the storage control portion 212 carries out a so called cash flash processing which deletes the written electronic information. Or, when the storage part 200 has a so called cash function to store the written electronic information as occasion demands, the storage control portion 212 removes this cash function.

According to the present embodiment, the electronic information to be written into the storage part 200 is always or, according to cases, temporarily stored in the memory 114, butter memory 222 or the like shown in FIG. 1; and, when the information writing confirmation becomes necessary, the check portion 213 may compare and check the temporarily stored written electronic information and the read-out electronic information for the coincidence thereof.

When it is found that the level of coincidence in these two kinds of electronic information is equal to or higher than a given level which allows the read-out electronic information and written electronic information to be determined as the same information, the writing of the relevant electronic information is determined successful (S15, Yes), thereby ending the electronic information writing processing.

When the level of coincidence is found lower than the given level (S15, No), the electronic information writing is determined as a failure and thus the storage control portion 212 controls again the storage part 200 to write the electronic information again (S12).

When the re-written electronic information is, for example, a given piece of important information and thus it is necessary to confirm the writing of the relevant electronic information (S13, Yes), the written electronic information is read out further again (S14) and the read-out electronic information is compared with the written electronic information. When the result of the comparison and check is good (S15, Yes), the information writing operation is ended. For example, when such writing confirmation enforcement conditions as will be mentioned below have not been generated, no information writing confirmation may be carried out on the re-written electronic information (S13, No). In this case, no confirmation processing is not executed but the information re-writing operation is ended.

Here, when the comparison and check shows that the information writing is a failure, as described above, positively, the data may be written again and the information comparison may be made again. However, for such information re-confirmation processing, for example, there may be set a timeout. Specifically, when the information writing is found poor successively a given number of times or more, a message “HDD is poor” may be displayed on a monitor or the like to thereby notify that the HDD is poor.

Next, description will be given below of the conditions for execution of the operation to confirm the writing of the electronic information. In FIG. 4, as a confirmation condition A, there are set the contents of the electronic information and, when this condition A is employed, for the so called important information that requires to secure the reliability of the writing thereof, there is carried out a writing confirmation operation. Whether electronic information in question is the important information that requires the confirmation of the writing thereof or not is determined, for example, by checking whether the relevant information is a given type of information or not, or whether it is the information to be stored into a given area or not, or whether it is information from a given function part or not.

For example, in a composite machine, information to be handled by the composite machine includes various types of information such as character information, image information and management information; and, more specifically, such information includes temporary storage information in copying, spool information in a printer, destination information (address information) in a FAX, receiving information, sending information, and read-in information from a scanner. Of these pieces of information, the spool information in the printer and copying machine is used temporarily and, even when it cannot be read, this information can be created again. On the other hand, for the receiving information and registered destination information in the FAX, when they cannot be read, they cannot be reconstructed again, which can raise a big obstacle to the operation of the system of the FAX or to the business of the user of the FAX. Also, in the disk 300 of the storage part 200, when management information for managing files is destructed once, in many cases, it is difficult to reconstruct the read-out information.

Thus, as given pieces of information which must be checked for the writing thereof, there may be set, for example, communication information (FAX information), destination information, accounting information and management information for managing files within the HDD.

The information corresponding to the writing confirmation condition A may be set by a user or may be previously set on the system side. Whether information corresponds to the condition or not can be checked according to, for example, the type of the information, specifically, according to whether the type of the information is a specified file type or not. When there is employed a file structure using an extension, the file type can be easily checked by the extension that is added to the rear of the file name of the information.

As an example of the file extension corresponding to important information, there are available, ****. jpg (image information, ****. fax (Fax information),****. sys (system information), and ****. csv (destination information. On the other hand, as the information that may not be checked for the writing thereof, in the case of the expansion of a file, there are available ****. tmp (temporary file), ****. log (log file), ****. bmp (bit map file), ****. prn (print file), and ****. scan (scan file).

When a file system employs a data management method for writing important information into a specific partition of a plurality of partitions logically delimited within an HDD, whether electronic information in question is to be checked for the writing thereof or not may also be determined according to whether the information is to be written into this specific partition (a given area) from the address information or the like. Also, when a file system employs a hierarchical directory and, for example, the above-mentioned fax information difficult to reconstruct is managed so as to be stored into a specific directory, whether information in question is information to be checked for the writing thereof or not may be determined according to whether the information is to be written into the specific directory, that is, the given area or not.

Also, the above information may also be determined according to from which function part it is supplied. For example, in the case of a signal supplied from the communication part 122, by setting it as the information that is to be checked for the writing thereof, for example, the communication information, destination information, sending destination log information, and receiving destination log information may also be controlled such that they can be written positively.

As described above, when the necessity of the check of information for the writing thereof is decided according to the type of information, the information to be checked may also be determined according to whether it can satisfy some or all of conditions. The relevant conditions, for example, may include: a condition that the information is of a given file type and is to be stored into a given area; a condition that the information is to be stored into a given area and is supplied from a specific function part; and, a condition that the information is of a specific file type and is supplied from a specific function part.

As a writing confirmation condition B, there is set a condition as to whether the writing environment of electronic information has been a given writing confirmation enforcement state or not. The given state of this writing confirmation condition B is the state of the storage part 200 that interferes with the writing of the electronic information: for example, vibrations generated due to the rotation of a motor used to feed paper serving as a recording medium; in the apparatus incorporating therein the image forming part 124 of an electrophotographic type, a state in which there are generated vibrations by a motor for rotating a sensitive drum; a state in which there are generated voltage variations caused by turning on and off the main power supply of the composite machine 100; and, a state in which there are generated electromagnetic noises caused by the flow of data through data buses in electronic circuits provided within the composite machine 100.

In a state where given vibrations are being generated within the composite machine 100 incorporating therein an HDD as the storage part 200, for example, the positioning precision and float height control of the head 262 are liable to be degraded, thereby raising a possibility that the writing of the information into the head 262 cannot be carried out properly. For example, in a composite machine system, there can be generated vibrations due to the operations of a large number of motors (for example, a drum drive motor and a paper feed motor) that are incorporated into the system.

Referring to the states of the operations of the motors used in a system, the degree of ill influences of the motors vibrations on the storage part composed of an HDD can differ from system to system depending on the position relationship of the motors with the HDD, the kinds and sizes of the motors, and the like. In a composite machine, as an example of a motor which can have a strong influence, there can be pointed out a main motor (a drum drive motor in the image forming part 124 of an electrophotographic type) and a motor for feeding paper serving as a recording medium.

In this manner, according to the writing confirmation condition B, there is executed an operation to check the writing of the electronic information that is written into the storage part during a period while the motors disposed within the composite machine and having a great influence are detected to be in operation, or during a period while a previously set motor is in operation. For example, on the electronic information that is written under the state where the drum drive motor of the composite machine is in operation, the check portion 213 enforces a writing confirmation (check) operation. When the writing operation is found as a failure (FIG. 3, S15, No), by writing the relevant electronic information again, the positive writing of the electronic information can be realized. The thus re-rewritten electronic information may also be checked further for the writing thereof.

Also, when it is found that the electronic information has not been written correctly, the storage control portion 212 instructs through the CPU 112 control means, which is used to control the operation of so called image forming means such as the image forming part 124, to stop the operation of the drive motor that is currently the vibration generating source. And, after the operation of the vibration generating source is stopped, the storage control portion 212 may also carry out a re-writing operation. In the above-mentioned example, when the writing of the same electronic information is found as a failure twice successively, the drum drive motor may be stopped and, after the writing of the electronic information is found successful, the operation of the drum drive motor may be resumed.

For the above-mentioned vibrations generated by the drive motor that is provided within the composite machine, the generation of the vibrations can be expected and grasped. However, vibrations generated in the composite machine by disturbances that are given from outside the storage part 200, for example, vibrations generated when setting paper or when recovering the state of the composite machine from the wrong state such as paper clogged state or when opening and closing a given unit part of the composite machine for the maintenance thereof, and vibrations generated when such given unit part collides with the composite machine, in some cases, cannot be expected on the composite machine side. In the storage part 200 using, besides the HDD, a head and a disk such as an optical disk, of the above-mentioned vibrations, the vibrations of such intensity as exceeding an allowable range are to be checked according to the writing confirmation enforcing condition regardless of the generating sources the vibrations.

Thus, in the composite machine, there may be mounted, for example, an acceleration sensor, an opening and closing sensor for opening and closing the cover of the composite machine 100, and an opening and closing sensor for opening and closing a paper supply tray. And, using detect information from these sensors, the generation of the vibrations may be detected; and, when such vibrations are generated, the check portion 213 is also allowed to carry out its writing confirmation processing.

Also, besides the above vibrations, electromagnetic noises can be generated and the power supply voltage can vary. As the electromagnetic noises, there can be pointed out the noises that are generated from inside the composite machine. And, as the noises generated from inside the composite machine, for example, in the composite machine, there is available static electricity which is generated when feeding the paper.

As the cause of the variations in the power supply voltage, there can be pointed out the instant drop of the voltage when turning on an electric motor or an air conditioning system disposed externally of the composite machine, the instant drop of a commercial power supply, great variations in the voltage when turning on the motors provided within the composite machine, and the like.

For the above-mentioned generation of the electromagnetic noises and variations such as the voltage variations, in a machine such as a composite machine incorporating a storage part therein, there may be provided a detect portion for detecting surge current and voltage and, using a detect signal supplied from the detect portion, the generation of the electromagnetic noises and voltage variations may be detected.

When the surge voltage and current due to the noises and voltage variations are generated, in an HDD or an optical disk shown in FIG. 2, the values of currents flowing in the head 262, amplifier 252 and motors 260, 264 are shifted from their respective proper values, thereby raising a possibility that the writing of the information can be impeded. Also, when the storage part uses, instead of a fixed disk such as an HDD, a nonvolatile semiconductor storage device such as a flash memory, since electronic information is electrically written into a memory element, the storage part is strong against vibrations. However, when there are generated surge voltage and current due to noises and power supply variations, there is raised a possibility that the information and memory element can be damaged or there can be generated a writing impediment such as the poor writing of the information.

Thus, when such so called electric variations are generated, such generation may be detected as a writing confirmation condition and the writing confirmation processing may be carried out. Owing to execution of the processing, even when such electric variations occur, the electronic information can be stored into the storage part 200 correctly.

According to a confirmation condition C shown in FIG. 4, as the determination reference thereof, there is used the presence or absence of a task to be written at the time when electronic information is written. When the next task to be written is not present, there is room for a writing processing in the storage part 200. Therefore, even when the writing of the electronic information is checked regardless of the importance of the electronic information, such writing check is difficult to have an influence on the operating speed of the composite machine. Thus, using such condition C, a writing confirmation processing may also be enforced.

Here, the above confirmation conditions A, B and C may also be employed as independent conditions respectively. In other words, only whether the electronic information is information corresponding to the given contents shown in the condition A or not (whether it is a given piece of important information or not) may be used as the writing confirmation condition; or, similarly, only on the electronic information that meets the given confirmation condition shown in the condition B, there may be enforced a writing confirmation processing; or, only on the electronic information meeting the condition C, there may be enforced a writing confirmation processing.

Also, when whether the electronic information is the information having the given contents stated in the confirmation condition A or not is used as an essential condition, in the composite machine incorporating therein a storage part, while preventing the reduced operation speed of the composite machine, the reliability of the storage of the important information can be easily improved. Also, even when the above-mentioned unintentional variations cannot be detected, it is possible to enhance the possibility that electronic information important for the composite machine can be stored automatically and positively. Further, on such important electronic information as meets the confirmation condition A, there may be carried out a writing confirmation processing and, at the same time, also when there occurs such writing confirmation enforcement condition as the confirmation condition B, there may be executed a writing check processing. In this case, for example, when the writing of the given important electronic information is confirmed and is found as a failure and, as described above, there is generated the confirmation enforcement condition due to vibrations generated within the composite machine, the operation of the motor generating such vibrations may be stopped immediately, which can realize the writing of the important information in a further earlier stage. Also, when the important electronic information is found as a failure for the writing thereof and also the occurrence of such disturbance as requires the enforcement of the writing confirmation processing is detected, the storage control portion 212 may enforce the control to write the important electronic information again after the state of the disturbance stops.

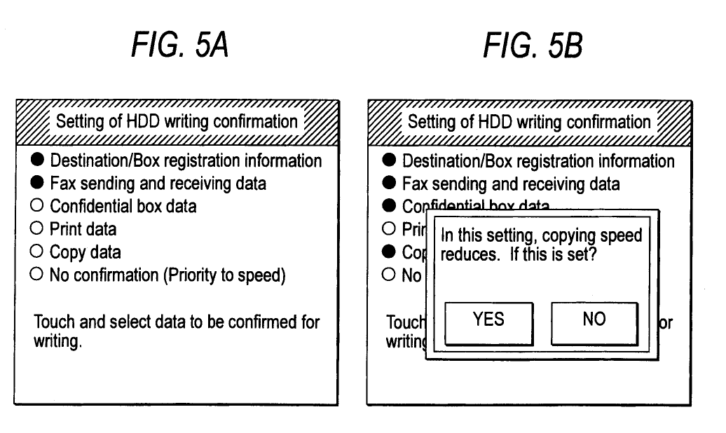

The above writing confirmation condition may partially or wholly be set arbitrarily by the user of a machine such as a composite machine. FIG. 5 shows the display examples of a screen for setting such writing confirmation condition. In the examples shown in FIG. 5, as items to be set, there can be selected (i) destination/box registration information, (ii) FAX sending and receiving data, (iii) confidential box data, (iv) print data, (v) copy data, or (vi) no writing confirmation. FIG. 5A shows a display example in which the above-mentioned items (i) and (ii) are selected; and, FIG. 5B shows a display example in which the items (i) to (iii) and (v) are selected. Since, as the number of information to be confirmed for writing increases, the operating speed of the machine reduces, for example, when a given number of items or more is selected or the item to reduce the operating speed is selected, there may be displayed on a monitor a message telling the reduction of the operating speed (for example, copying speed), thereby notifying this message to the user of the machine.

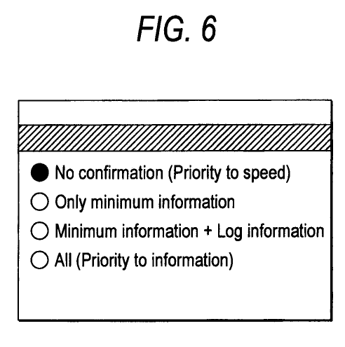

Also, as shown in FIG. 6, the setting items for confirmation of writing may be fixed. For example, the user may set any one of the following items: that is, (i) no confirmation (priority to speed), (ii) only minimum information, (iii) minimum information and log information, and (iv) total information (priority to information). Here, the log information may include, for example, the communication log and communication error log of FAX, a composite machine error log, and an accounting log. When the item to be confirmed is (iv) total information or (iii) minimum information and log information, similarly to the example shown in FIG. 5B, there may also be notified of a message telling that the operating speed of the machine is reduced.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An electronic information storage apparatus comprising:
a storage that stores electronic information;
a check unit that reads out the electronic information stored in the storage to check whether the electronic information is written normally or not; and
a controller that, in a case where the electronic information is stored in the storage under a predetermined condition, controls the check unit to carry out an operation to check a state of writing of the electronic information.

2. The electronic information storage apparatus as claimed in claim 1,
wherein
the predetermined condition specifies that the electronic information is a predetermined kind of information.

3. The electronic information storage apparatus as claimed in claim 1,
wherein
the predetermined condition specifies that the electronic information is information to be stored into a predetermined area of the storage.

4. An information processing apparatus comprising:
a storage that stores the electronic information;
a check unit that reads out the electronic information stored in the storage to check whether the electronic information is written normally or not; and
a controller that, in a case where the electronic information is stored in the storage under a predetermined condition, controls the check unit to carry out an operation to check a state of writing of the electronic information.

5. The information processing apparatus as claimed in claim 4,
wherein
the predetermined condition specifies that, as the electronic information, address information of communication is stored into the storage.

6. The information processing apparatus as claimed in claim 4,
wherein
the predetermined condition specifies that a predetermined piece of image information is stored into the storage.

7. An image forming apparatus comprising:
an image forming unit that forms an image on a recording medium;
a storage that stores electronic information;
a check unit that reads electronic information stored in the storage to check whether the electronic information is written normally or not; and
a controller that, in a case where the electronic information is stored in the storage under a predetermined condition, controls the check unit to carry out an operation to check a state of writing of the electronic information.

8. The image forming apparatus as claimed in claim 7,
wherein
the predetermined condition specifies that accounting information about a formation of an image information by the image forming unit is stored in the storage.

9. The image forming apparatus as claimed in claim 7,
wherein
the predetermined condition specifies that previously determined vibrations are generated from the image forming unit.

10. The image forming apparatus as claimed in claim 7,
wherein
the predetermined condition specifies that previously determined electromagnetic noises are generated from the image forming unit.

11. The image forming apparatus as claimed in claim 7, further comprising:
an image formation controller that controls the operation to be carried out by the image forming unit,
wherein
the check unit carries out an operation to check a state of writing of re-written information, and
the image formation controller, in the state of writing of the re-written electronic information is determined as a failure, controls the image forming unit to stop the operation to generate predetermined vibrations.

12. An image forming apparatus comprising:
an image forming unit that forms an image on a recording medium;
a storage that stores electronic information;
a check unit that reads electronic information stored in the storage to check whether the electronic information is written normally or not;
a detect unit that detects vibrations of the storage; and
a controller that, in a case where the detect unit detects vibrations, controls the check unit to carry out an operation to check a state of writing of the electronic information.

13. The electronic information storage apparatus as claimed in claim 1,
wherein
the controller, in a case where a next operation instruction to the storage does not exist at a time when the electronic information is written into the storage, controls the check unit to check whether the electronic information has been written normally or not.

14. The information processing apparatus as claimed in claim 4,
wherein
the controller, in a case where a next operation instruction to the storage does not exist at a time when the electronic information is written into the storage, controls the check unit to check whether the electronic information has been written normally or not.

15. The image forming apparatus as claimed in claim 7,
wherein
the controller, in a case where a next operation instruction to the storage does not exist at a time when the electronic information is written into the storage, controls the check unit to check whether the electronic information has been written normally or not.

16. A computer readable medium storing a program causing a computer to execute a process for storing electronic information, the process comprising:
reading out electronic information;
checking whether the electronic information is written normally or not; and
controlling, in a case where the electronic information is stored under a predetermined condition, the computer to carry out an operation to check a state of writing of the electronic information.
